(19) United States
(12) Patent Application Publication
(10) Pub. No.: US 2009/0201871 A1
(43) Pub. Date: Aug. 13, 2009

(54) EFFICIENT UTILIZATION OF CHANNEL RESOURCES IN WIRELESS COMMUNICATION

(75) Inventors: Sharad Deepak Sambhwani, San Diego, CA (US); Bibhu P. Mohanty, San Diego, CA (US); Mehmet Yavuz, San Diego, CA (US); Rohit Kapoor, San Diego, CA (US); Vinay Chande, San Diego, CA (US)

Correspondence Address: QUALCOMM INCORPORATED, 5775 MOREHOUSE DR., SAN DIEGO, CA, 92121, US

(73) Assignee: QUALCOMM, Incorporated, San Diego, CA (US)

(21) Appl. No.: 12/369,261

(22) Filed: Feb. 11, 2009

Related U.S. Application Data
(60) Provisional application No. 61/028,068, filed on Feb. 12, 2008.
(60) Provisional application No. 61/028,168, filed on Feb. 12, 2008.

(51) Int. Cl. H04W 4/00

(52) U.S. Cl. 370/329

(57) ABSTRACT

Providing for improved wireless communications for user equipment (UE) in a semi-active state is described herein. By way of example, a base station can employ particular wireless channel resources, monitored by a UE in a CELL_FACH state for instance, to trigger channel feedback information from the UE. The trigger can comprise an explicit order instructing the UE to provide data in response, or can include a portion of downlink traffic targeting the UE, where the UE is configured to respond in a suitable manner to receipt of traffic data. The UE can maintain the CELL_FACH state in receiving to and responding to the trigger, and can further receive subsequent traffic data in such state. Accordingly, the subject disclosure provides for improved efficiency and reliability in semi-active state wireless communications.

### CLAIM OF PRIORITY UNDER 35 U.S.C. §119

The present Application for patent claims priority to:

U.S. Provisional Application No. 61/028,068 entitled EFFICIENT UTILIZATION OF DL HS-RESOURCES IN CELL_FACH filed Feb. 12, 2008; and

U.S. Provisional Application No. 61/028,168 entitled EFFICIENT UTILIZATION OF DL HS-RESOURCES IN CELL_FACH, filed Feb. 12, 2008, each of which are assigned to the assignee hereof, and hereby expressly incorporated by reference herein.

### BACKGROUND

I. Field

The following relates generally to wireless communication, and more specifically to triggering uplink feedback in conjunction with delivering downlink data to terminals in a CELL_FACH state.

II. Background

Wireless communication systems are widely deployed to provide various types of communication content such as, e.g., voice content, data content, and so on. Typical wireless communication systems can be multiple-access systems capable of supporting communication with multiple users by sharing available system resources (e.g., bandwidth, transmit power). Examples of such multiple-access systems can include code division multiple access (CDMA) systems, time division multiple access (TDMA) systems, frequency division multiple access (FDMA) systems, orthogonal frequency division multiple access (OFDMA) systems, and the like.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth.

In a planned deployment of wireless access networks, air signal interference can result from transmissions by access points (e.g., base stations) as well as access terminals. Uplink Interference within a particular cell can be caused by random movements of access terminals within the cell or within neighboring cells, for instance. Downlink interference, at least for a planned deployment of wireless access points, typically occurs from one cell to another; but can also occur between multiple transmitters within a cell, especially with semi-planned or un-planned deployments.

To help reduce interference on the downlink, mobiles can obtain channel quality information (CQI) pertaining to one or more wireless resources. The CQI could describe channel interference, path-loss, scattering, packet-loss, or the like. CQI is typically submitted by an access terminal to a base station serving that terminal. Utilizing the CQI information, the base station can then adjust transmit power, employ different wireless resources, utilize or modify antenna diversity, or other techniques to reliably deliver downlink data to the access terminal.

In addition, the base station typically delivers a schedule of transmissions to inform the access terminal of what data to expect, when to expect it, and on what resources. By referencing the schedule of transmissions, the access terminal can determine whether all or only a portion of data intended for the access terminal is received. For each block (e.g., packet) of data in the schedule, the access terminal responds to the base station with an acknowledgment (ACK) or negative acknowledgment (NACK). If a scheduled packet is received and decoded properly, an ACK is sent to the base station; otherwise, if the scheduled packet is not received or not decoded properly, a NACK is sent to the base station. Based on the ACK/NACK feedback, the base station can determine what downlink packets need to be retransmitted.

Without a feedback mechanism, base stations would likely need to transmit full packet streams multiple times, consuming far greater wireless resources for a downlink transmission, and extending overall communication time. Even in such case, delivery of all packets would not be assured. Accordingly, packet scheduling and feedback play significant roles in reliable wireless communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The subject disclosure provides for improved wireless communications for user equipment (UE) in a CELL_FACH state. A base station can employ shared channel resources, monitored by CELL_FACH UEs, to trigger channel feedback information. Thus, for instance, the base station can transmit downlink data to the UE based on channel quality information (CQI) obtained at the mobile, improving downlink reliability and reducing packet loss. In addition, ACK/NACK feedback can be triggered by the base station, mitigating redundancy in downlink transmissions. Accordingly, the subject disclosure provides for improved efficiency and reliability in wireless communications.

In some aspects of the subject disclosure, provided is a method of wireless communication within a wireless network. The method can comprise employing a communication interface to exchange wireless signals with one or more wireless UE and employing a data processor to generate a message for a UE in a CELL_FACH state. Furthermore, the method can comprise employing the communication interface to trigger an uplink response from the UE in the CELL_FACH state by transmitting the message to the UE.

In other aspects of the subject disclosure, provided is an apparatus for wireless communication in a wireless network. The apparatus can comprise a communication interface that facilitates transmitting or receiving data OTA via wireless communication signals. Additionally, the apparatus can comprise a traffic module that identifies inbound traffic for a UE in a CELL_FACH state. Moreover, the apparatus can comprise a feedback module that sends a message to the UE to trigger an uplink response from the UE, wherein the uplink response is employed by the data processor to transmit the inbound traffic over the communication interface.

According to one or more additional aspects, disclosed is an apparatus for wireless communication in a wireless network. The apparatus can comprise means for employing a communication interface to exchange wireless signals with one or more wireless UE and means for employing a data processor to generate a message for a UE in a CELL_FACH state. Furthermore, the apparatus can comprise means for employing the communication interface to trigger an uplink response from the UE in the CELL_FACH state by transmitting the message to the UE.

In still other aspects, provided is at least one processor configured for wireless communication in a wireless network. The processor can comprise a first module that employs a communication interface to exchange wireless signals with one or more wireless UE. In addition, the processor can comprise a second module that generates a message for a UE in a CELL_FACH state. Moreover, the processor can comprise a third module that triggers an uplink response from the UE in the CELL_FACH state by transmitting the message to the UE.

In at least one aspect, the subject disclosure provides a computer program product comprising a computer-readable medium. The computer-readable medium can comprise a first set of codes for causing a computer to employ a communication interface to exchange wireless signals with one or more wireless UE. Further, the computer-readable medium can comprise a second set of codes that causes the computer to generate a message for a UE in a CELL_FACH state. Additionally, the computer-readable medium can comprise a third set of codes that causes the computer to employ the communication interface to trigger an uplink response from the UE in the CELL_FACH state by transmitting the message to the UE.

Further to the above, the subject disclosure provides a method of facilitating efficient wireless communications. The method can comprise employing a wireless communication interface of a UE in a CELL_FACH state to receive system or traffic information from a wireless network AP. The method can also comprise employing at least one processor to analyze received shared control channel signals from the AP in accordance with the CELL_FACH state. In addition, the method can comprise employing the wireless communication interface to submit channel information on an uplink in response to a message received from the AP via the shared control channel.

In other aspects of the subject disclosure, provided is an apparatus for facilitating efficient wireless communication in a wireless network. The apparatus can comprise a wireless communication interface for sending or receiving data via wireless signals. The apparatus can additionally comprise a data processor for analyzing wireless signals transmitted by an AP of the wireless network. Furthermore, the apparatus can comprise a network-response module that identifies a shared control channel message transmitted by the AP and transmits an uplink message in response to the shared control channel message.

In one or more other aspects of the subject disclosure, provided is an apparatus configured to facilitate efficient wireless communications. The apparatus can comprise means for employing a wireless communication interface configured in a CELL_FACH state to receive system or traffic information from a wireless network AP and means for employing at least one processor to analyze received shared control channel signals from the AP in accordance with the CELL_FACH state. In addition, the apparatus can comprise means for employing the wireless communication interface to submit channel information on an uplink in response to a message received from the AP via the shared control channel.

According to further aspects, disclosed is at least one processor configured to facilitate efficient wireless communications. The processor(s) can comprise a first module that employs a wireless communication interface of a UE in a CELL_FACH state to receive system or traffic information from a wireless network AP. In addition, the processor(s) can comprise a second module that analyzes received shared control channel signals from the AP in accordance with the CELL_FACH state. Moreover, the processor(s) can comprise a third module for employing the wireless communication interface to submit channel information on an uplink in response to a message received from the AP via the shared control channel.

In at least one aspect, disclosed is a computer program product comprising a computer-readable medium. The computer-readable medium can comprise a first set of codes for causing a computer to employ a wireless communication interface configured in a CELL_FACH state to receive system or traffic information from a wireless network AP. The computer-readable medium can further comprise a second set of codes for causing the computer to analyze received shared control channel signals from the AP in accordance with the CELL_FACH state. In addition to the foregoing, the computer-readable medium can comprise a third set of codes for causing the computer to employ the wireless communication interface to submit channel information on an uplink in response to a message received from the AP via the shared control channel.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects can be employed and the described aspects are intended to include all such aspects and their equivalents.

### BRIEF DESCRIPTION OF THE DRAWINGS

FIG. 1 depicts a block diagram of sample system for providing improved downlink communication in wireless communications.

FIG. 2 depicts a block diagram of an example system for facilitating improved downlink communication according to further aspects.

FIG. 3 illustrates a block diagram of a sample system that triggers uplink feedback for improved downlink transmissions for CELL_FACH UEs.

FIG. 4 illustrates a block diagram of a sample system messaging exchange to facilitate the improved downlink communication in some aspects.

FIG. 5 depicts a block diagram of an example base station configured to trigger uplink feedback from CELL_FACH UEs.

FIG. 6 depicts a block diagram of a sample UE configured to provide feedback data in a CELL_FACH state according to further aspects.

FIG. 7 illustrates a flowchart of an example methodology for providing improved downlink transmissions in wireless communications.

FIG. 8 illustrates a flowchart of a sample methodology for triggering downlink transmission feedback for a UE in a CELL_FACH state.

FIG. 9 depicts a flowchart of a sample methodology for facilitating improved downlink transmissions in wireless communications.

FIG. 10 illustrates a flowchart of an example methodology for responding to an uplink feedback order in a CELL_FACH state.

FIGS. 11 and 12 depict block diagrams of example systems for providing and facilitating, respectively, feedback from UEs in a CELL_FACH state.

FIG. 13 illustrates a block diagram of a sample apparatus for wireless communications according to some aspects of the subject disclosure.

FIG. 14 depicts a block diagram of an example mobile communication environment according to further aspects of the subject disclosure.

FIG. 15 illustrates a block diagram of a sample cellular communication environment according to additional aspects of the subject disclosure.

Appendix A provides an example that demonstrates potential inefficiency of downlink transmission without uplink feedback for CELL_FACH UEs.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It can be evident, however, that such aspect(s) can be practiced without these specific details. In other instances, well-known structures and devices are shown in block diagram form in order to facilitate describing one or more aspects.

In addition, various aspects of the disclosure are described below. It should be apparent that the teaching herein can be embodied in a wide variety of forms and that any specific structure and/or function disclosed herein is merely representative. Based on the teachings herein one skilled in the art should appreciate that an aspect disclosed herein can be implemented independently of any other aspects and that two or more of these aspects can be combined in various ways. For example, an apparatus can be implemented and/or a method practiced using any number of the aspects set forth herein. In addition, an apparatus can be implemented and/or a method practiced using other structure and/or functionality in addition to or other than one or more of the aspects set forth herein. As an example, many of the methods, devices, systems and apparatuses described herein are described in the context of providing reliable and efficient downlink transmissions in a wireless environment. One skilled in the art should appreciate that similar techniques could apply to other communication environments.

Wireless communication systems implement information exchange between wireless nodes by employing various signaling mechanisms. In one instance, a base station can be employed to transmit pilot signals that establish timing sequences and identify signal source and network associated with the source, among other things. A remote wireless node, such as a user terminal (UT) or access terminal (AT), can decode a pilot signal to obtain information necessary to establish basic communication with the base station. Additional data, such as a wireless frequency or set of frequencies, time slot(s), symbol codes and the like can be conveyed in control signals transmitted from the base station. This data can be utilized to establish wireless resources over which traffic data, carrying user information, such as voice communication or data communication, can be conveyed between the base station and UT.

One significant problem in such a system is interference between wireless transmissions of nearby wireless nodes. Interference can reduce reception quality, retard throughput, or render communication ineffective when severe. Accordingly, planned base station deployments are ideal in that wireless nodes can be placed at a suitable distance to mitigate interference. However, even in planned networks downlink interference can result, for instance when traffic load becomes large, when terminals are at an edge of a service area, or the like. Furthermore, in semi-planned or unplanned deployments (e.g., comprising individually owned base stations installed with little or no network operator guidance), interference problems are exacerbated.

To mitigate overlapping transmissions and resulting signal interference, wireless communications are typically structured in time, frequency, or on various code or symbol resources, to enable signals to be distinguished from other signals. For instance, transmitting at different times enables distinction, as well as transmitting on orthogonal frequencies. Furthermore, employing orthogonal codes or symbols can also yield mitigated interference, even for signals transmitted at a common point in time. In such a manner, wireless resources can be segmented to enable multiple nodes to operate in a given wireless environment.

In addition to interference or packet-loss problems, mobile terminals are typically configured for various network-interface states to prolong finite battery resources at the terminal. Specifically, different interface states (e.g., or modes of operation with the network) can comprise different protocols that have differing effects on power consumption. Typically, a primary consumer of battery power in a terminal is processing resources involved in analyzing downlink signals, and in transmitting signals to a network. Thus, when engaged in active wireless traffic communication, significant power consumption occurs. However, when the terminal's processor, memory, etc., are idle or infrequently active, much less power is consumed.

Based on the foregoing, various terminal operation states or operation modes are configured for different degrees of wireless activity, to provide for different degrees of power consumption. As utilized in the written description and appended claims, a semi-active state refers to a UE interface state, mode of operation, etc., in which the UE analyzes fewer received signals or transmits less frequently than when engaged in active traffic transmission (e.g., in conjunction with a voice or data call). The semi-active state enables the UE to consume less power than an active state, in which the UE analyzes a significantly larger portion of received signals and transmits more data relative the semi-active state. Examples of low power operation states include idle mode, CELL_FACH state, CELL_PCH state and CELL_DCH state, or similar. In an idle mode, the terminal can preserve significant power by monitoring minimal network signals (e.g. paging signals and periodic acquisition pilots). In a CELL_PCH state, the terminal can monitor a physical channel (PCH—such as a synchronization pilot) in addition to paging channels, and utilize slightly more power (e.g., 10% more) than in the idle mode. In a CELL_FACH state, the terminal can monitor shared channels, paging channels and acquisition pilots and utilize more power than the idle state or CELL_PCH states. Likewise, the terminal could join and monitor dedicated channels in a CELL_DCH state, consuming much more power relative the other states. The terms idle mode, CELL_PCH, CELL_FACH, and CELL_DCH are utilized herein with substantially similar meaning as provided by third generation partnership project (3GPP) specifications (e.g., 3GPP Specification TS 25.331), except where specified herein to the contrary. It should be appreciated, however, that the subject disclosure and appended claims are not limited to the foregoing terminal states, except where explicitly indicated.

One working assumption in some high speed (HS) radio access networks (RANs) is real-time or near real-time configuration of wireless channels based on current wireless conditions in a network. For instance, in some 3GPP networks, a HS dedicated physical control channel (HS-DPCCH) is employed by a user equipment (UE) to send uplink feedback information to a wireless access point for use in scheduling downlink (DL) transmissions. As a particular example, 3GPP Release 8 (Rel. 8) provides for downlink physical channel configuration in response to an uplink transmission on a dedicated channel (e.g., an HS-DPCCH). In such case, a UE can be configured to provide channel quality information (CQI), packet acknowledgement or negative acknowledgment (ACK/NACK) data, or other suitable information, in conjunction with the uplink transmission. Based on the CQI data, ACK/NACK data, and so forth, downlink transmissions can be reliably implemented for the UE. However, in certain terminal states, such as idle mode states or CELL_FACH states, typical UEs can be configured to submit uplink channel information infrequently. Accordingly, downlink data is often scheduled without the benefit of channel feedback information, packet reliability information, and so on. This can result in significant network inefficiency and delay for the downlink transmissions (e.g. see Appendix A).

Additionally, in the 3GPP context, HS-DPCCH transmissions are often useful or utilized only when a UE has data to send on an E-DCH. In many cases, when the HS-DPCCH is transmitted, no downlink data exists to be delivered to the UE, and hence the HS-DPCCH is of limited utility. This in turn results in unnecessary processing at the base station.

Further to the above, in a CELL_FACH state for instance, when downlink (DL) transmissions on a HS channel do not overlap with uplink (UL) transmissions on E-DCH, the HS transmissions are often sent blindly, employing a number of re-transmissions to improve data receptivity. Such a case can occur where ACK/NACK or CQI data is not available or current, for instance where a UE has not recently sent an E-DCH transmission. Conversely, if a DL transmission coincides with UL transmission on the E-DCH, a base station scheduler can make use of ACK/NACK or CQI information when scheduling DL transmissions for the CELL_FACH UE. Without the feedback information, blind transmission on HS channels often leads to significant loss in high speed downlink packet access and highly inefficient implementation of DL HS resources.

To remedy the foregoing problems, the subject disclosure provides for network-initiated feedback for UEs in semi-active states. In some aspects of the subject disclosure, a base station can send a feedback order on a channel monitored by the UE, based on the UEs state. Such an order can be sent when the base station has downlink data for the UE. In addition, the order can optionally be conditioned on the UE being in a particular semi-active state, or failure to receive feedback from the UE for a threshold time, or the like.

As a particular example to illustrate the foregoing, if the UE is in a CELL_FACH state, the base station can send an order to the UE over channels monitored in a CELL_FACH state (e.g., a shared control channel) to send feedback. As another example, if the UE is in an idle mode state, the order to the UE to send feedback can be sent over a channel monitored in the idle mode state (e.g., a paging channel). In at least one example, the order can be sent after a threshold time passes without obtaining feedback data from the UE.

Once a UE receives a feedback order, the UE can perform random access procedures as provided by a wireless network, in order to obtain a channel to transmit the feedback data (e.g., ACK/NACK, CQI). In at least one aspect of the subject disclosure, a feedback order transmitted by a base station can specify particular uplink resources for the uplink feedback. In such aspect(s), the UE can forego random access procedures and transmit on the specified uplink resources.

According to one or more further aspects of the subject disclosure, a base station can trigger uplink feedback by transmitting a portion of traffic data to the UE, in conjunction with or in lieu of a feedback order. Specifically, the base station can segment DL traffic into at least a first portion and a second portion. In some aspects, the first portion (e.g., an initial data packet) can be smaller than the second portion (e.g., the remaining data packets of the DL traffic). The base station sends the first portion of the traffic to the UE, optionally employing blind retransmission if CQI or ACK/NACK data is not available. Upon receiving the first portion, the UE can then respond to the received traffic data using RLC ACKs or STATUS PDUs. In order to transmit the Radio Link Control (RLC) ACK/STATUS Protocol Data unit (PDU), the UE may perform random access procedures, as part of which it may acquire a common uplink resource. The UE can then start sending CQI/ACK using the acquired common uplink resource. The base station can then send the remaining data efficiently using CQI/ACK information transmitted by the UE.

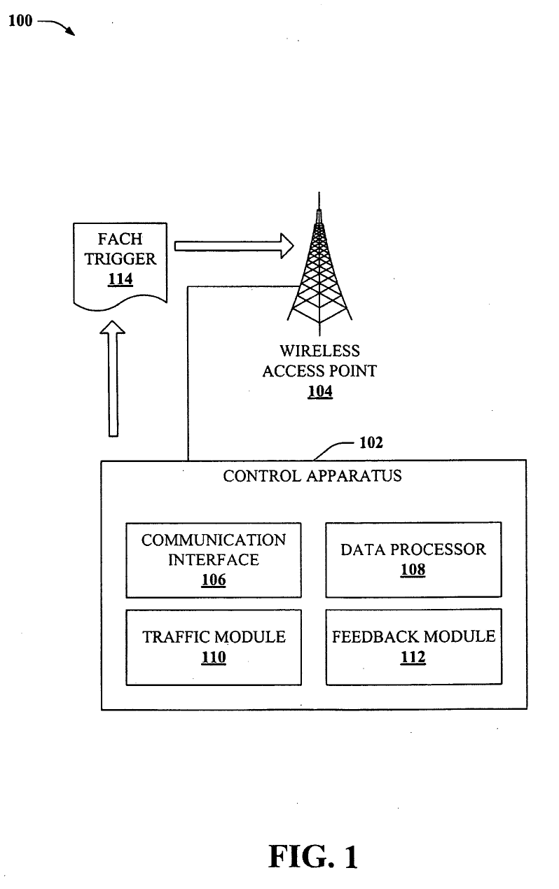

Referring now to the figures, FIG. 1 depicts a block diagram of an example system 100 that can trigger uplink feedback from wireless nodes in a wireless network. For instance, the system 100 can provide service for one or more UEs (not shown) within the wireless network, or a cell thereof. In some circumstances, the UEs can enter a power saving mode to preserve battery power. In such circumstances, the UE might infrequently provide channel quality or packet acknowledgement information to the base station, reducing reliability of DL transmissions transmitted by system 100. However, by triggering uplink feedback for the power saving mode(s), system 100 can improve downlink communication reliability within the wireless network.

System 100 can comprise a control apparatus 102 coupled with a radio access network (RAN) access point 104. A communication interface 106 can employ the wireless access point 104 to send and receive wireless signals to/from UE's served by a cell of a wireless network. DL wireless signals sent by the AP/communication interface 104, 106 can be scheduled by control apparatus 102, and UL signals can be decoded or analyzed by control apparatus 102.

To this end, control apparatus 102 can comprise a set of data processors 108 configured to analyze received wireless symbols. In some aspects of the subject disclosure, the received symbols can be employed by control apparatus 102 in scheduling DL transmissions. For instance, data processor(s) 108 can decode and extract data pertaining to a wireless channel employed by system 100. The extracted data can then be employed by control apparatus to select suitable wireless DL resources, suitable transmit power, re-transmit selected data packets, and so forth, to facilitate efficient wireless communications.

Control apparatus 102 can further comprise a traffic module 110 that can identify inbound traffic for a particular UE. In at least some aspects of the subject disclosure, the traffic module 110 can identify inbound traffic for a UE in a semi-active state (e.g., for conserving terminal power as compared with an active state), such as a CELL_FACH state. Where suitable, traffic module 110 can cause feedback module 112 to trigger an uplink message from the UE. For instance, where control apparatus 102 has not recently received channel quality information, or where an ACK/NACK message is not received in response to a DL transmission sent by system 100, feedback module 112 can trigger the uplink message from the UE. Specifically, feedback module 112 can send a message to the UE to trigger an uplink response from the UE. Such an uplink response can comprise feedback information employed by control apparatus 102 to schedule DL data, to determine successful receipt of data packets at the UE, or similar wireless communication functions.

In some aspects of the subject disclosure, feedback module 112 can generate a shared control channel (SCCH) message to trigger the uplink response from the UE. As utilized herein, an SCCH message can include a HS-SCCH message, or other suitable shared channel of a wireless network for sending state or status information, resource assignment information, transmission scheduling information, or other control information pertaining to nodes of a wireless network. Furthermore, the message can specify an identity (ID) of an uplink resource utilized for the response, or can specify no resource and allow the UE to perform an access function to obtain network-assigned uplink resources. In some aspects, the uplink response can specify information pertaining to a HS-DPCCH. In at least one aspect of the subject disclosure, the message can comprise an order to transmit CQI or ACK/NACK information regarding downlink transmissions. The control apparatus 102 can employ the uplink response information in scheduling the downlink transmissions for the UE. Where the UE is in a semi-active state, such downlink transmissions can comprise, for instance, PUSH data from mobile network servers (e.g., a stock or ticker quote from a stock quote server, a chat message from a chat server, presence data from a presence server, telemetry sensor virtual private network [VPN] data from an associated server, e-mail from an e-mail server, and so forth), a session Internet protocol (SIP) INVITE sent to a destination UE in a mobile-to-mobile voice over Internet protocol (VoIP) call (e.g., to reduce VoIP call setup delay), and so on.

By triggering the feedback response from the UE, control apparatus 102 can obtain channel quality or packet information while the UE is in a low activity state, preserving batter power. Thus, system 100 can increase battery life of mobile terminals, while providing high efficiency downlink transmissions. Furthermore, the trigger can be implemented only when DL data is ready to be transmitted to the UE, as determined by the traffic module 110. Accordingly, system 100 enables the UE to avoid periodically sending uplink data when in a low activity state (e.g., CELL_FACH state) until the uplink data can be utilized by a network access point. System 100 therefore can provide optimal efficiency in many circumstances.

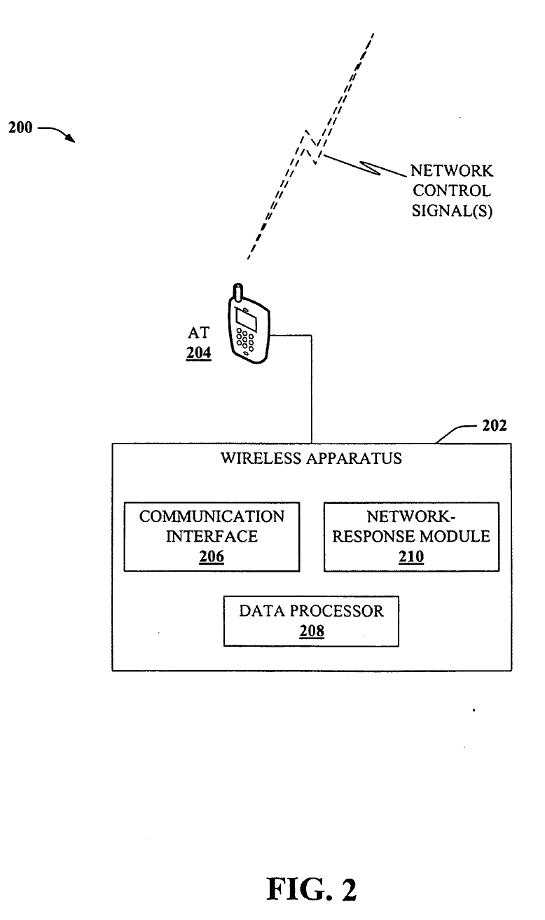

FIG. 2 depicts a block diagram of an example system 200 that facilitates efficient wireless signaling in wireless communications. System 200 can comprise an AT 204 comprising a wireless communication apparatus 202. The AT 204 can be in various activity states, including a reduced activity or semi-active state, such as a CELL_FACH state, idle mode state, CELL_PCH state, or the like. In such a state, AT 204 can employ a communication interface 206 to receive and monitor at least one network control signal transmitted by a network entity (not depicted). Such control signal can comprise a paging signal, a shared channel signal, a broadcast channel (BCH) signal, a pilot signal, and so on, depending on the activity state and network protocols governing such state.

In at least one aspect of the subject disclosure, AT 204 can utilize an E-DCH channel specified by a network RNC for uplink transmission. Additionally, the AT 204 can monitor a shared channel signal of a network, and employ at least one data processor 208 to analyze data transmitted via the shared channel signal. Furthermore, a network-response module can identify a shared channel message from the analyzed data pertinent to the AT 204. In some aspects of the subject disclosure, the shared channel message can comprise an SCCH message, or an HS-SCCH message.

Upon identifying the shared channel message, network-response module 210 can take one or more appropriate actions in response to the message. In one aspect of the subject disclosure, the network-response module can identify and respond to an order to submit an uplink message in response to the shared channel message. The uplink message can comprise various feedback information, such as channel information, packet information, or other information suitable for effecting efficient wireless communications in a wireless network. As one particular example, the uplink message can comprise ACK/NACK data identifying received or missed DL packets, respectively. In another example, the uplink message can comprise CQI information for a particular channel.

Further to the above, the network-response module can determine whether the shared channel message specifies an ID of an uplink resource for transmission of the response message. If a resource is specified, the AT 204 can acquire the uplink resource and for transmitting the response message. For instance, the shared channel message could specify an ID of an E-DCH channel for the uplink response. Particularly, the E-DCH ID could comprise an N-bit identifier, where N is a suitable positive integer (as an example, 5), specifying a particular common E-DCH resource. If such a resource ID is specified, the AT 204 can avoid network access procedures in obtaining an uplink channel, thereby reducing delay in transmitting the response message.

If no resource ID is specified, the AT 204 can perform a random access protocol to obtain network-assigned uplink resources. Once obtained, the response message is transmitted to the network. In some aspects of the subject disclosure, wireless communication apparatus 202 can identify a timing specification for the uplink response from the shared channel message. In such aspects, the timing specification can indicate a delay time for transmitting the uplink response, after receiving the shared channel message, for instance. Where no timing specification is provided by the shared channel message, suitable response timing can be selected by wireless communication apparatus 202.

According to further aspects of the subject disclosure, network-response module 206 can monitor analyzed data provided by processor(s) 208 to identify traffic data transmitted to AT 204 (e.g., transmitted on a resource specified as a traffic resource). If such traffic data is identified, AT 204 can employ the communication interface 206 to initiate random access procedures to acquire a common channel from a wireless network. Utilizing the common channel, AT 204 can then employ the network-response module 210 to submit RLC ACK/STATUS PDU, CQI information or packet ACK/NACK responses pertinent to the traffic data. In some instances, the AT 204 can transition from a semi-active state to an active state to engage in active traffic communication upon receiving the traffic data and sending the ACK/NACK or CQI information. Alternatively, AT 204 can remain in a semi-active state, receiving network PUSH data, while responding with uplink data as provided by a protocol associated with the semi-active state, or as specified by DL transmissions. Accordingly, AT 204 can implement efficient wireless communications based on various types of DL signaling or traffic information received from a network.

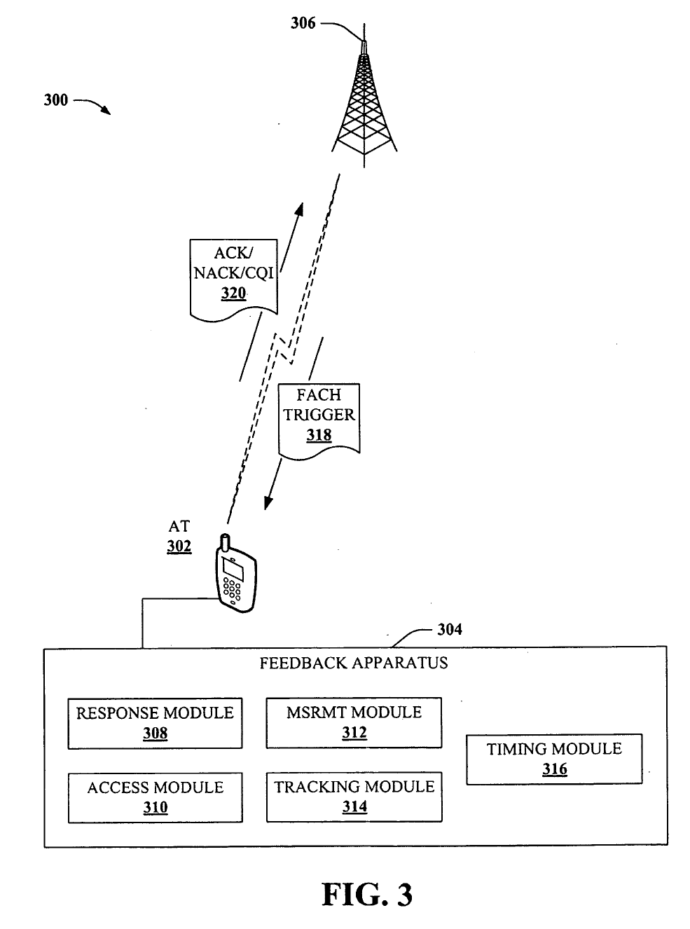

FIG. 3 depicts a block diagram of a sample system 300 for wireless data exchange in a wireless communication environment. More particularly, system 300 can provide improved efficiency for the wireless data exchange, for terminals in various activity states. As one example, system 300 can provide reduced power consumption while maintaining efficient wireless protocols for an AT (302) in a CELL_FACH state.

System 300 can include an AT 302 comprising a feedback apparatus 304. Additionally, the AT 302 can be communicatively coupled with a network base station 306 via one or more wireless channels. In at least some aspects of the subject disclosure, AT 302 can be configured to utilize a CELL_FACH state to reduce power consumption, employing protocols specified by a wireless network associated with the base station 306 for the CELL_FACH state. For instance, while in the CELL_FACH state, AT 302 can monitor a forward access channel (FACH) employed by the base station 306 for DL data transmission or signaling. In at least some aspects of the subject disclosure, the FACH can comprise a HS-SCCH.

The AT 302 can employ feedback apparatus 304 to monitor received wireless data transmitted by base station 306 and identify a circumstance requiring uplink data to be transmitted by AT 302 to base station 306. One example circumstance requiring uplink data transmission can include receipt of a FACH trigger message 318 transmitted to AT 302 over an HS-SCCH. Particularly, feedback apparatus 304 can analyze the FACH trigger message 318 to identify an uplink channel order contained in such message 318. If the feedback apparatus 304 identifies such an order, an uplink message can be generated and submitted in response to the order. Another example circumstance requiring uplink data transmission can comprise identification of traffic data transmitted by base station 306 to AT 302. Thus, if feedback apparatus 304 identifies traffic data, the uplink message is generated and submitted to base station 306, to facilitate high quality DL transmissions.

Feedback apparatus 304 can comprise a network-response module 308 for analyzing an SCCH employed by base station 306 and identifying an SCCH message transmitted over the SCCH. If such a message is identified, network-response module 308 can additionally determine whether channel information or packet response information, or both, should be transmitted to the base station 306. As one example, network-response module 308 can be configured to transmit CQI if an order to provide uplink response data is identified in FACH trigger message 318. As another example, network-response module 308 can be configured to transmit CQI information as well as ACK/NACK information upon identifying the uplink response order. It should be appreciated, however, that the subject disclosure and appended claims are not limited to the foregoing examples.

In addition to the foregoing, feedback apparatus 304 can comprise a measurement module 312 that analyzes one or more wireless channels employed by base station 306 to obtain the CQI. Such information can comprise interference information, path loss information, signal scattering information, channel noise information, or like information affecting transmission or reception of wireless data. Once obtained, the measurement module 312 can provide the CQI to network-response module 308 for transmission to base station 306, as described herein.

Furthermore, feedback apparatus 304 can comprise a packet tracking module 314 that determines successful data packet reception at AT 302. The determination can be made by referencing data packets decoded and analyzed by AT 304, and comparing such data packets with a packet schedule transmitted by base station 306. Packet tracking module 314 can generate an ACK for each packet specified by the packet schedule that is successfully received and decoded by AT 302. Furthermore, packet tracking module 314 can generate a NACK for each specified packet that is either not received or not decoded successfully by AT 302. The ACK/NACK information can be provided to network-response module 308 for transmission to base station 306.

In addition to the foregoing, feedback apparatus 304 can also comprise a timing module 316. Timing module 316 can be employed to determine appropriate response timing for uplink data transmitted to the base station 306. For instance, timing module 316 can employ one or more protocols compatible with a network associated with base station 306 to determine the appropriate response timing. Alternatively, or in addition, timing module 316 can analyze the FACH trigger 318 transmitted by the base station 306 for the appropriate response timing. Once determined, timing module 316 can schedule an uplink response according to the determined response timing, providing timing coordination between AT 302 and base station 306.

Once suitable ACK/NACK or CQI is obtained, network-response module 308 can generate an uplink message 320 in response to the FACH trigger 318. If an uplink resource is specified within the FACH trigger 318, network-response module 308 can employ the specified resource for sending the uplink message 320. If no resource is specified, an access module 310 can be employed to initiate a random channel access procedure. In response to the procedure, AT 302 can receive a network-assigned uplink resource (e.g., an E-DCH resource) for the uplink message 320. Once received, the uplink message 320, including the ACK/NACK or CQI information, is sent to base station 306. The base station 306 can employ the ACK/NACK or CQI information in scheduling further DL data for transmission to AT 302. Thus, for instance, where a NACK is received in the uplink message 320, base station 306 can retransmit a data packet associated with the NACK. Furthermore, base station 306 can refrain from retransmitting data packets associated with an ACK included in the uplink message 320. Additionally, the scheduling can be configured based on CQI information specified in the uplink message 320. Thus, suitable DL channel resources can be employed to mitigate potential DL interference, a suitable transmit power can be chosen for the DL data to mitigate interference for other DL data in a wireless network, and so on.

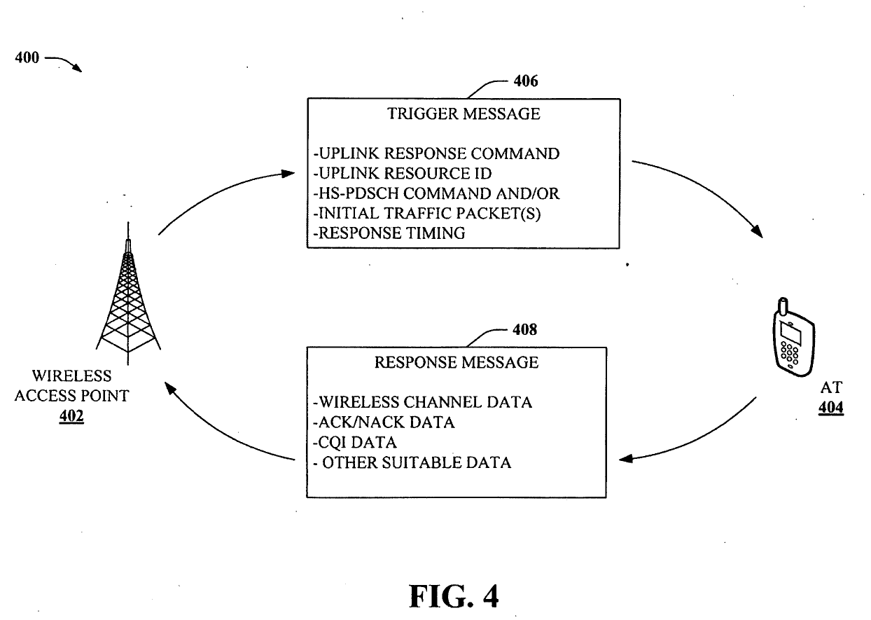

FIG. 4 depicts a block diagram of an example wireless communication environment 400 according to further aspects of the subject disclosure. The wireless communication environment 400 can comprise a wireless network access point 402 communicatively coupled with an AT 404 via one or more wireless channels. To improve efficiency of DL transmissions, wireless access point 302 can generate and send a trigger message 406 to the AT 404, requesting uplink feedback data from the AT 404. In response to the trigger message 406, AT 404 can provide a response message 408 over suitable uplink channels. Accordingly, the wireless base station 402 can schedule subsequent transmissions based at least on information provided in the response message, to improve communication efficiency between the access point 402 and AT 404. It should be appreciated that in at least some aspects of the subject disclosure, the AT 404 can be operating in a reduced activity state (e.g., a semi-active state), as described herein. Accordingly, the improved communication efficiency can be achieved while preserving power consumption for the AT 404, providing significant advantages for the wireless communication environment 400 as a whole.

In addition to the foregoing, wireless access point 402 can include various information in the trigger message 406. As an example, the trigger message 406 can be an HS-SCCH message, and can include an explicit command or order for the AT 404 to provide feedback information. In at least one aspect of the subject disclosure, the explicit command can, for instance, comprise a HS-PDSCH command. Furthermore, the HS-PDSCH command can instruct the AT 404 to transmit HS-DPCCH data in conjunction with DPCCH data on an uplink. According to additional aspects, the trigger message 406 can specify a particular wireless channel resource to be used for the uplink. For instance, the trigger message 406 can specify an E-DCH resource utilizing an N-bit resource identifier (e.g. a 5-bit identifier). As a particular example, the N-bit resource identifier can employ unused bit combinations of an HS-SCCH to identify the E-DCH resource.

In at least one aspect of the subject disclosure, the trigger message 406 can comprise an initial data packet or set of packets of a stream of traffic data routed to the AT 404. Such packet(s) can be in addition to or in lieu of the uplink response command. Furthermore, the packet(s) can be transmitted on a set of wireless resources recognized as traffic resources by the AT 404. Accordingly, the AT 404 can respond to the traffic data as determined by a traffic protocol (e.g. by providing packet ACK/NACK information or CQI). As a specific example, the AT 404 can receive the initial data packet(s) and perform a random access procedure and acquire a common uplink resource. Utilizing the common uplink resource, the AT 404 can respond to the received traffic data utilizing RLC ACKs or STATUS PDUs. Additionally, the AT 404 can send CQI or ACK/NACK information using the acquired common uplink resource. Upon receiving the RLC ACKs, STATUS PDUs, or CQI/ACK information, the wireless network access point 402 can send the remaining traffic data packets efficiently based on the feedback provided by the AT 404.

The response message 408 generated by AT 404 and transmitted to the wireless access point 402 can include suitable data for effecting efficient wireless communication between the access point 402 and AT 404. For instance, the response message 408 can include wireless channel data, descriptive of wireless conditions on one or more DL resources. Additionally, the response message 408 can include ACK/NACK data pertaining to data packets received by AT 404, and CQI data pertaining to interference, packet loss, etc., on the DL resources. It should also be appreciated that AT 404 can include other suitable data related to wireless communication in the response message 408, in addition to or in lieu of other data specified above.

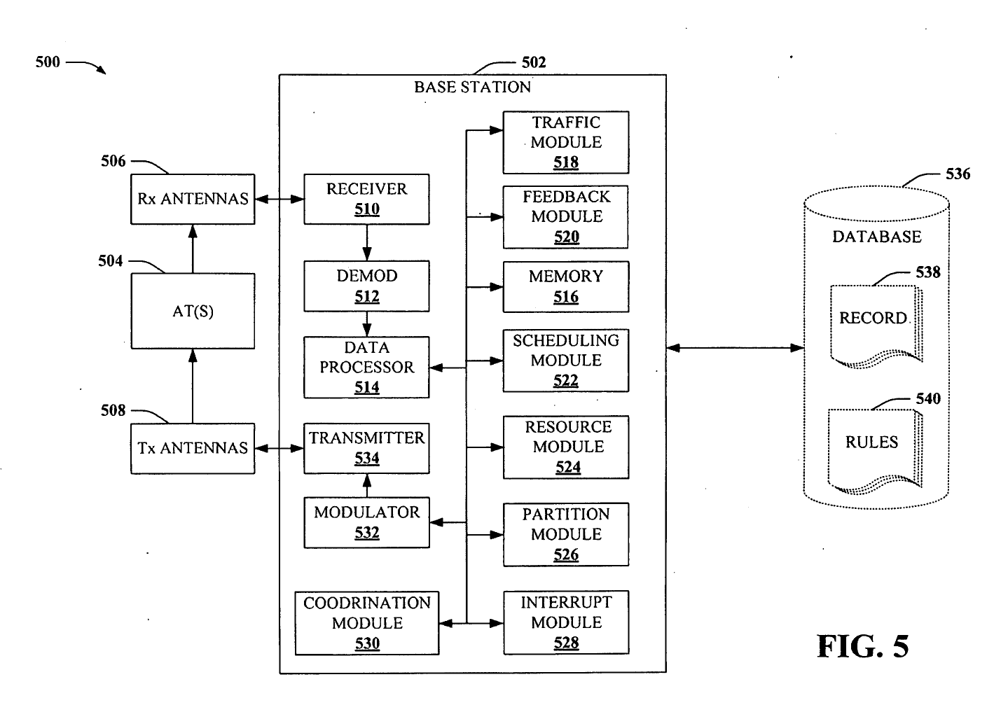

FIG. 5 depicts a block diagram of an example system 500 according to aspects of the subject disclosure. Specifically, system 500 can comprise a base station 502 configured for triggering data from a remote wireless device in conjunction with wireless communication with such device. For instance, base station 502 can be configured to obtain CQI or ACK/NACK data from one or more ATs 504 near to or within a coverage area served by the base station 502. Configurations employed by base station 502 can be stored in respective rules records 540 at a database 536. Additionally, respective CQI or ACK/NACK data can be stored in respective records 538 of the database 536 associated with respective ATs 504. Furthermore, it should be appreciated that base station 502 can trigger submission of uplink data from an AT 504 in a semi-active state (e.g., CELL_FACH state) that is not monitoring traditional feedback channels of a wireless network. Data pertaining to such an AT(s) 504 can be initialized to a special record (534) for fast access. Alternatively, or in addition, the special record can be maintained in temporary memory (516) to further facilitate the fast access.

Base station 502 (e.g., access point, . . . ) can comprise a receiver 510 that obtains wireless signals from one or more of the ATs 504 through one or more receive antennas 506, and a transmitter 534 that sends coded/modulated wireless signals provided by modulator 532 to the one or more ATs 504 through a transmit antenna(s) 508. Receiver 510 can obtain information from receive antennas 506 and can further comprise a signal recipient (not shown) that receives uplink data transmitted by AT(s) 504. Additionally, receiver 510 is operatively associated with a demodulator 512 that demodulates received information. Demodulated symbols are analyzed by a communication processor 514. Communication processor 514 is coupled to a memory 516 that stores information related to functions provided or implemented by base station 502. In one instance, stored information can comprise rules or protocols for parsing wireless signals and obtaining and decoding feedback information provided by one or more of the UT(s) 504.

Further to the above, base station 502 can employ a traffic module 518 configured to identify inbound traffic for an AT 504 in a CELL-FACH state. To reliably transmit such traffic to the AT 504, base station 502 can employ a feedback module 520 to send a message to the AT 504 triggering an uplink response. Furthermore, the message can be transmitted to the AT 504 on a wireless resource monitored by the CELL_FACH AT (504), such as a shared channel (e.g. a shared control channel). According to some aspects of the subject disclosure, the feedback module 520 can include an explicit order for the CELL_FACH AT (504) to transmit the uplink response. In other aspects, the feedback module 520 can send a set of initial traffic packets to the CELL_FACH AT (504), in lieu of or in addition to the explicit order, to trigger the uplink response. In either case, the trigger message can additionally comprise an uplink resource ID, such as a 5-bit E-DCH ID, determined by a resource module 524. The AT 504 can utilize the uplink resource ID to acquire an uplink channel for transmitting the uplink response.

In some aspects of the subject disclosure, base station 502 can further comprise a scheduling module 522 that instructs the AT 504 to transmit HS-DPCCH uplink data in conjunction with DPCCH uplink data. The scheduling module 522 can provide the instruction to the feedback module 520 for inclusion into the trigger message. In such a manner, relatively small delay in providing the uplink response can be achieved, as the CELL_FACH AT (504) can be pre-configured to transmit the DPCCH data in many circumstances, so that the HS-DPCCH is transmitted concurrently or shortly after the DPCCH data.

Where the feedback module 520 includes traffic packets in the trigger message, a partition module 526 can be employed by the base station 502 to segment DL traffic targeting the CELL_FACH AT (504) into one or more data segments (e.g. packet segments). In such case, the partition module 526 can provide an initial traffic segment to be included within the trigger message, causing the CELL_FACH AT (504) to provide ACK/NACK or CQI data upon decoding the initial traffic segment. Additionally, the base station 502 can employ a traffic interruption module 528 to delay transmission of subsequent segments of the traffic packets, at least until the ACK/NACK or CQI data is received from the CELL_FACH AT (504). In such a manner, the subsequent traffic packets can be scheduled based on the ACK/NACK or CQI data, yielding improved efficiency over blind transmission of the traffic data (e.g., transmission without ACK/NACK or CQI data).

According to further aspects of the subject disclosure, base station 502 can comprise an uplink coordination module 530. The uplink coordination module 530 can be configured to specify a response time in submitting the uplink response to the trigger message. Specifically, the response time can comprise a particular delay period (e.g., 50-60 milliseconds) after receiving the trigger message, after which the CELL_FACH AT (504) should send the response message. In such a manner the base station 502 can attempt to anticipate when the response message should be received, and further anticipate when to schedule remaining traffic data segmented by the partition module 526. Accordingly, overall delay in triggering uplink data, receiving a response and scheduling traffic data can be reduced or optimized by base station 502.

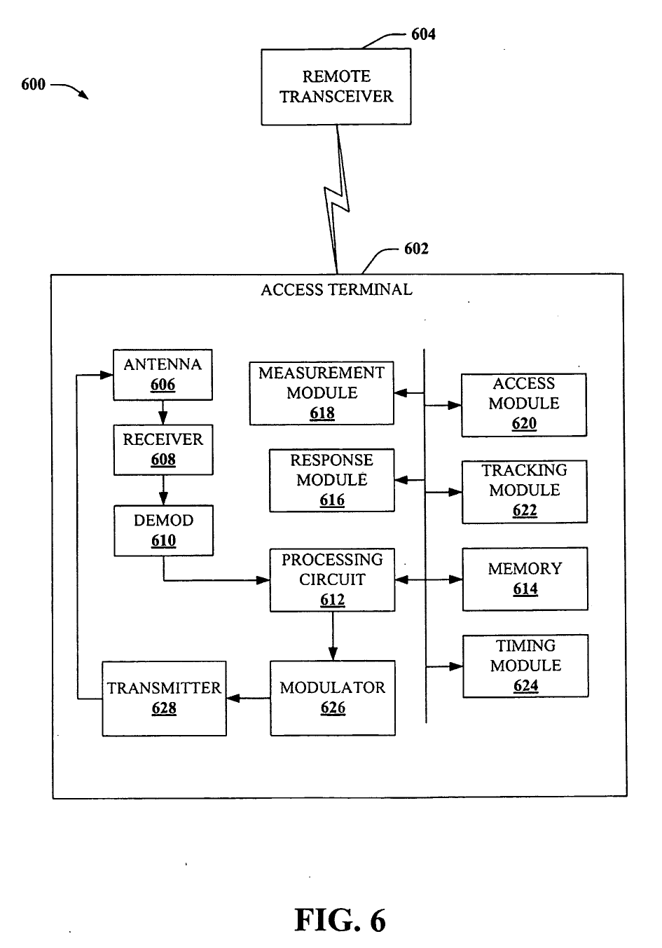

FIG. 6 depicts a block diagram of an example system comprising an AT 602 configured for wireless communication according to aspects of the subject disclosure. AT 602 can be configured to wirelessly couple with one or more remote transceivers 604 (e.g., access point) of a wireless network. Based on such configuration, AT 602 can receive wireless signals from a base station (504) on a forward link channel and respond with wireless signals on a reverse link channel. In addition, AT 602 can comprise instructions stored in memory 614 for analyzing received wireless signals, identifying an uplink response trigger, generating feedback data for an uplink response, and transmitting a message comprising such data in response to the trigger, as described herein.

AT 602 includes at least one antenna 606 (e.g., a wireless transmission/reception interface or group of such interfaces comprising an input/output interface) that receives a signal and receiver(s) 608, which performs typical actions (e.g., filters, amplifies, down-converts, etc.) on the received signal. In general, antenna 606 and a transmitter 628 (collectively referred to as a transceiver) can be configured to facilitate wireless data exchange with remote transceiver(s) 604.

Antenna 606 and receiver(s) 608 can also be coupled with a demodulator 610 that can demodulate received symbols and provide such signals to a processing circuit(s) 612 for evaluation. It should be appreciated that processing circuit(s) 612 can control and/or reference one or more components (606, 608, 610, 614, 616, 618, 620, 622, 624, 626, 628) of the AT 602. Further, processing circuit(s) 612 can execute one or more modules, applications, engines, or the like (616, 618, 620, 622, 624) that comprise information or controls pertinent to executing functions of the AT 602. For instance, such functions can include employing active and semi-active states and transitioning between such states. In addition, functions can include identifying an uplink trigger message in a received wireless signal, generating channel quality or packet reliability data, determining appropriate timing for responding to the trigger message, or like operations, as described herein.

Additionally, the memory 614 of AT 602 is operatively coupled to processing circuit(s) 612. Memory 614 can store data to be transmitted, received, and the like, and instructions suitable to conduct wireless communication with a remote device (504). Specifically, the instructions can be utilized to implement the various functions described above, or elsewhere herein. Further, memory 614 can store the modules, applications, engines, etc. (616, 618, 620, 622, 624) executed by processing circuit(s) 612, above.

AT 602 can further comprise a network-response module 616 for providing an uplink message in response to a trigger condition. Such condition can include receiving a feedback command over a channel monitored by AT 602 (e.g., an SCCH channel monitored while AT 602 is in a semi-active state, such as a CELL_FACH state). Alternatively, or in addition, the trigger condition can include receiving traffic data from remote transceiver 604. Where a feedback command specifies particular uplink resources for the uplink message, AT 602 can acquire such resources and transmit the message thereon. Otherwise, network-response module 616 can employ an access module 620 to initiate a random channel access procedure to obtain the uplink resources.

Feedback information included in the response message can include ACK/NACK data, determined from a packet tracking module 622, or CQI data determined from a measurement module 618. Specifically, packet tracking module 622 can monitor packets received from the remote transceiver and compare such packets to a packet scheduling record specified in a DL transmission. An ACK can be generated for packets received by AT 602 and properly decoded by processing circuit(s) 612, whereas a NACK can be generated for un-received or improperly decoded packets. The ACK(s)/NACK(s) can be provided to network-response module 616. Likewise, the measurement module 618 can analyze one or more resources of one or more signals received by AT 602 and determine interference, packet loss, scattering or noise data related to such signals/resources, and provide such data as CQI to the network-response module 616.

Additionally, as described herein, AT 602 can comprise a timing module for determining suitable timing for responding to a feedback trigger condition on an uplink. The timing can be, for instance, a delay in transmitting the response message after identification of a trigger condition, mentioned above (e.g., a SCCH message comprising traffic data or a feedback order). The timing can be predetermined according to a protocol utilized by remote transceiver 604, or can be extracted from a signal transmitted by the remote transceiver 604. Based on the timing information, network-response module 616 can transmit the uplink response at a time anticipated by the remote transceiver 604, to facilitate optimal coordination and minimal delay in the uplink response.

The aforementioned systems have been described with respect to interaction between several components, modules and/or communication interfaces. It should be appreciated that such systems and components/modules/interfaces can include those components or sub-components specified therein, some of the specified components or sub-components, and/or additional components. For example, a system could include AT 404 coupled with feedback apparatus 304, and base station 402 coupled with control apparatus 102, or a different combination of these or other components. Sub-components could also be implemented as components communicatively coupled to other components rather than included within parent components. Additionally, it should be noted that one or more components could be combined into a single component providing aggregate functionality. For instance, access module 310 can include network-response module 308, or vice versa, to facilitate submitting an uplink response to a wireless access point and obtaining an uplink resource for the submission by way of a single component. The components can also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

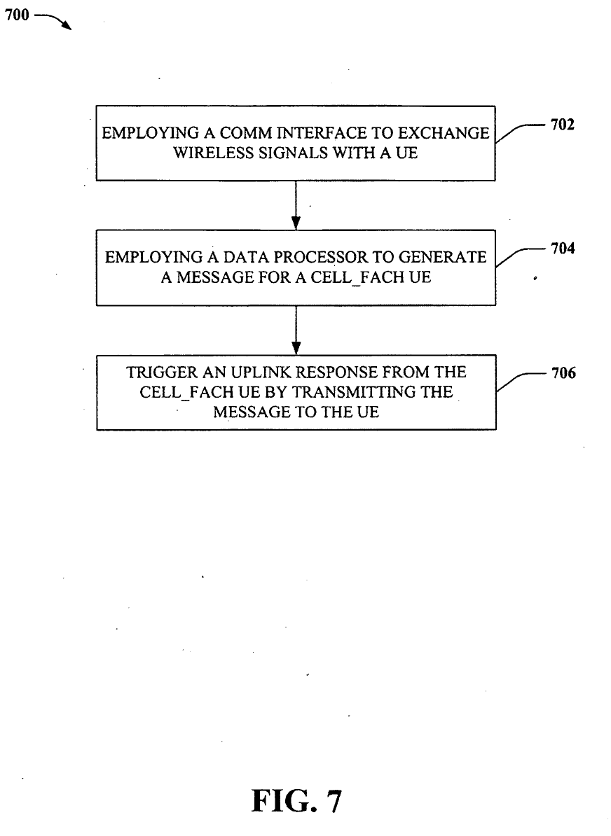

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or storage medium.

FIG. 7 depicts a flowchart of a sample methodology 700 for providing improved efficiency in wireless communications, according to one or more aspects of the subject disclosure. At 702, method 700 can employ a communication interface to exchange wireless signals with a UE. Particularly, the UE can be in a semi-active mode, such as an idle state, CELL_FACH state, or the like. Accordingly, the wireless signals can be a set of signals which the UE is configured to send or receive data on in accordance with the semi-active mode.

At 704, method 700 can employ a data processor to generate a message for the UE. The message can be configured for at least one channel monitored by the UE, based on a state or mode that the UE is in. Thus, for instance, the message can be an SCCH message for a UE in a CELL_FACH state, or other suitable channel or resource employed by the UE in such a state.

At 706, method 700 can trigger an uplink response from the UE by transmitting the message to the UE. To facilitate triggering the response, the message can comprise an explicit order for such a response, optionally including particular data to be included by the UE in the response. Additionally, the message can comprise a channel or resource ID for use in submitting the uplink response. Accordingly, time required for the UE to acquire and access a particular channel can be minimized, reducing the overall response time for the response message.

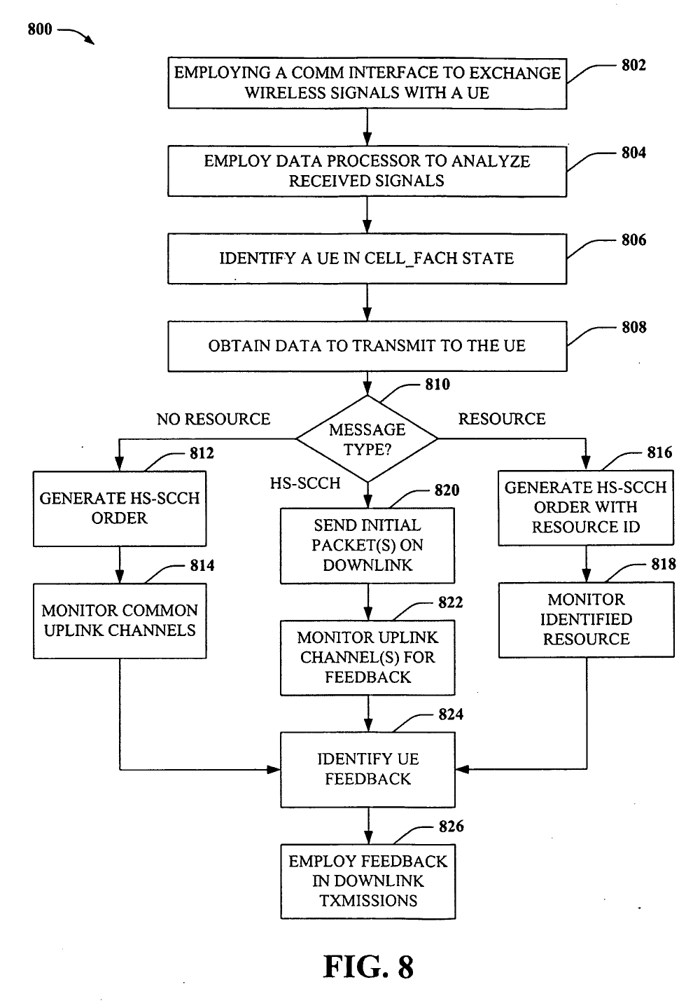

FIG. 8 illustrates a flowchart of an example methodology 800 for triggering an uplink response for a UE in a CELL_FACH state. At 802, method 800 can employ a communication interface to exchange wireless signals with the UE. At 804, method 800 can employ a data processor to analyze signals received from the UE. Based on the analyzed signals or a channel or resource on which the signals are transmitted by the UE, method 800 can identify whether the UE is in the CELL_FACH state, at 806. Furthermore, at 808, method 800 can obtain data to transmit to the UE. Such data can include traffic data pertaining to a voice or data call involving the UE. In at least some aspects of the subject disclosure, the traffic can comprise network PUSH data, such as an SIP INVITE for VoIP calling, server PUSH data, such as a stock or ticker quote, chat message, presence message, telemetry sensor VPN data, e-mail message, and so on.

At 810, method 800 can determine a suitable type of message for triggering an uplink response from the CELL_FACH UE. If the message is a resource specified message, method 800 can proceed to 816. If the message is resource independent, method 800 can proceed to 812. Otherwise, if the message is an HS-SCCH traffic message, method 800 can proceed to 820.

At 812, method 800 can generate an HS-SCCH order to submit uplink transmission data. At 814, method 800 can monitor random access uplink channels to identify a channel acquired by the UE. Such acquisition can be in response to a random channel access procedure implemented by the UE, for instance. Method 800 can proceed from reference number 814 to 824.

At 816, method 800 can generate an HS-SCCH order to submit uplink transmission data, and specify an ID of a resource to transmit the uplink data. The ID resource can be, for instance, an E-DCH resource. In such case, the ID can be an N-bit identifier suitable for distinguishing the E-DCH resource from one or more other wireless resources of a wireless network. Additionally, at 818, method 800 can monitor the identified resource for the uplink response submitted by the UE. Method 800 can them proceed from reference number 818 to 824.

At 820, method 800 can segment traffic data targeting the UE into one or more segments. At least one of the segments can be included into an HS-SCCH message, transmitted to the UE. At 822, method 800 can monitor uplink channels for the response to the at least one traffic segment, where the uplink channel can be a Layer 2 channel such as RLC and the received response can be an RLC ACK/STATUS PDU. As an example, the monitored uplink channel can be an uplink channel corresponding to the HS-SCCH.

At 824, method 800 can identify feedback data provided by the UE and received on one or more monitored channels. Subsequently, the feedback data can be decoded and employed in scheduling or sending DL data to the UE. For instance, CQI information included in the feedback data can be employed to identify suitable channels or channel resources to mitigate interference, reduce path loss or scattering, or the like. As another example, ACK/NACK data included in the feedback can be employed for retransmission protocols pertaining to prior data transmissions. It should be appreciated that, in at least one instance of the subject disclosure, method 800 can be implemented while the UE remains in the CELL_FACH state. Accordingly, the DL data can be delivered with the advantage of feedback data provided by the UE, while the UE maintains the CELL_FACH state to preserve power and battery life.

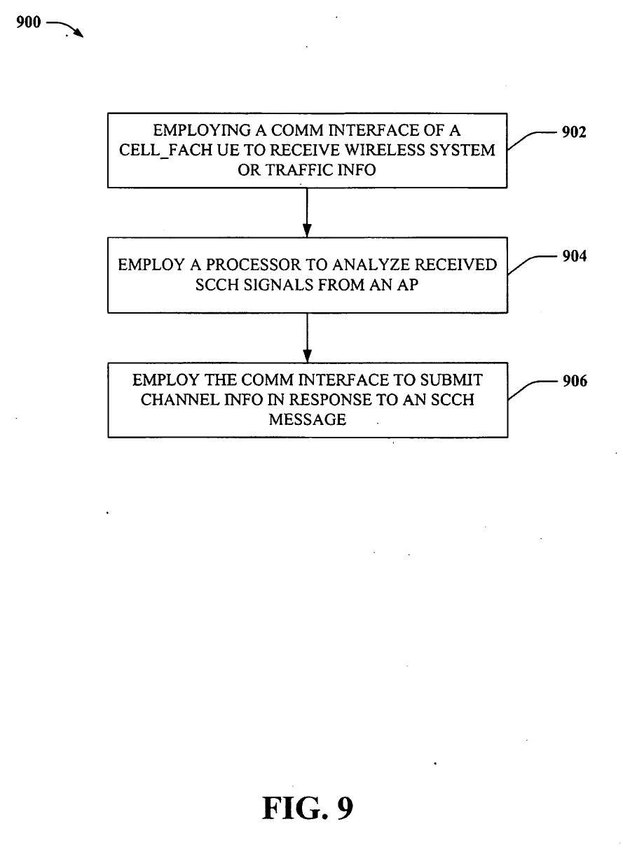

FIG. 9 depicts a flowchart of an example methodology 900 for facilitating improved communication in a wireless network environment. At 902, method 900 can employ a communication interface of a CELL_FACH UE to receive wireless system or traffic information, as described herein. Additionally, at 904, method 900 can employ a data processor or set of processors to analyze received SCCH signals transmitted by a network access point. Furthermore, at 906, method 900 can employ the communication interface to submit channel or packet quality information to the access point. Particularly, such submission can be in response to receiving an SCCH message over the SCCH channel. Furthermore, it should be appreciated that the UE can maintain the CELL_FACH state while the SCCH message is received and the response is submitted.

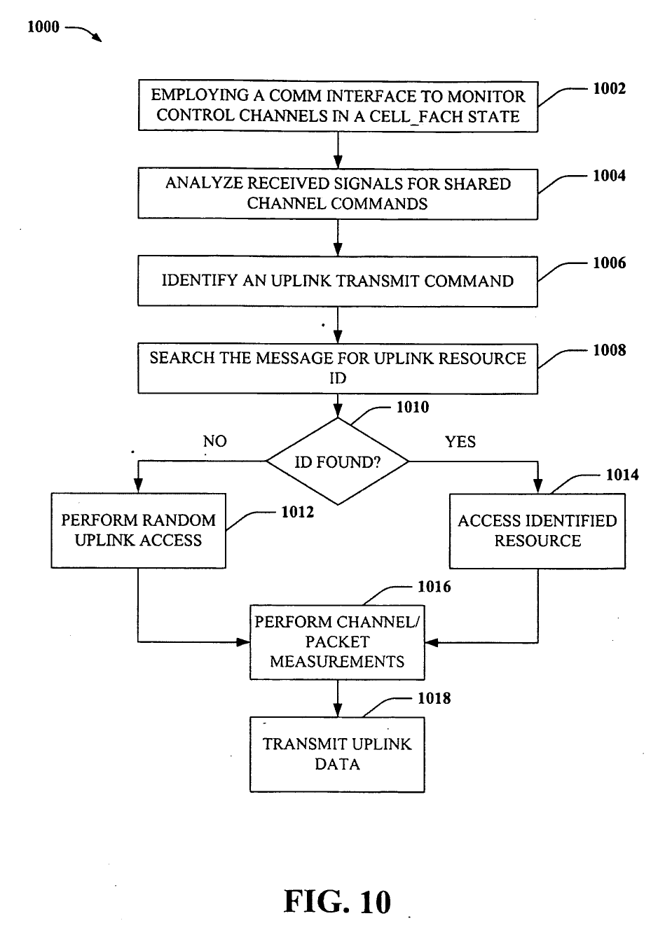

FIG. 10 illustrates a flowchart of a sample methodology 1000 for facilitating improved efficiency in wireless communications. At 1002, method 1000 can employ a communication interface of a CELL_FACH UE to monitor control channels of a wireless network, as described herein. At 1004, method 1000 can analyze received signals on the monitored control channels for shared channel commands. At 1006, method 1000 can identify an uplink transmission command from a monitored control channel. At 1008, method 1000 can search the message for an uplink resource ID.

At 1010, method 1000 can make a determination as to whether the uplink resource ID is found. If so, method 1000 can proceed to 1014. Otherwise, method 1000 proceeds to 1012.

At 1012, method 1000 can perform a random uplink access procedure if the resource ID is not found with the uplink transmission command. In response to the procedure, a suitable uplink resource can be identified and acquired for transmission of uplink data. From reference number 1012, method 1000 can proceed to 1016.

At 1014, method 1000 can access a resource specified by the resource ID determined at reference number 1010. Additionally, at 1016, method 1000 can perform channel or packet measurements suitable for responding to the uplink transmission command. The measurements can comprise wireless channel quality measurements for gathering CQI data. Alternatively, or in addition, the measurements can comprise packet tracking measurements to generate ACK/NACK feedback regarding packet receipt. In at least one aspect of the subject disclosure, the channel or packet measurements can be utilized to acknowledge an RLC, or status of a protocol data unit. At 1018, data resulting from the channel or packet measurements (e.g. RLC ACK/STATUS PDU, CQI or ACK/NACK data) can be transmitting on an uplink resource, acquired at reference number 1012, or 1014. Additionally, if a resource release command is received, method 1000 can release the resource after transmitting the channel or packet measurements.

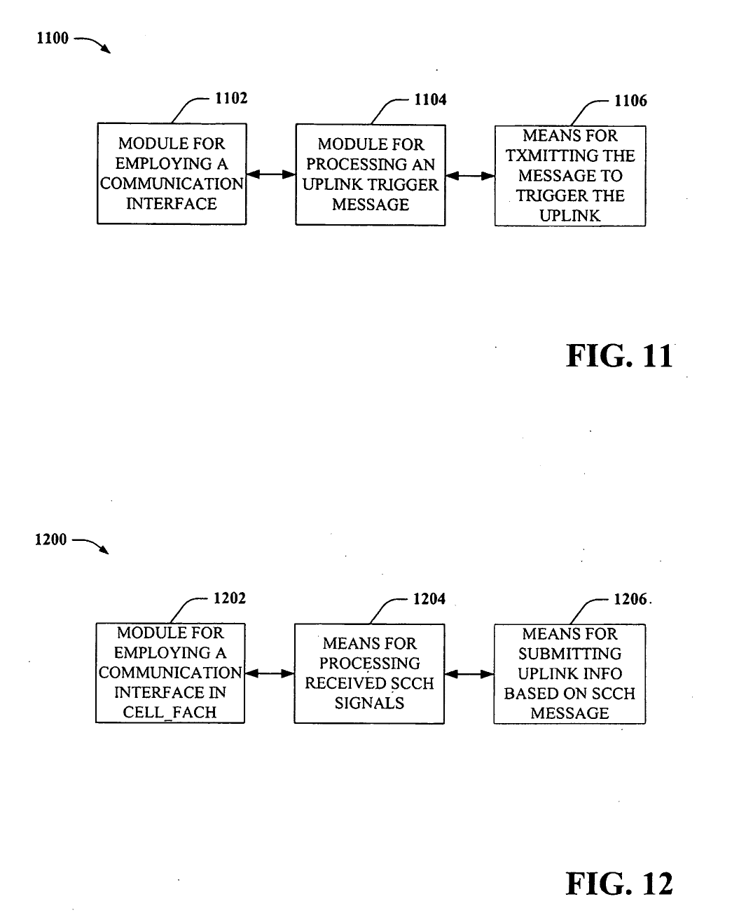

FIGS. 11 and 12 depict block diagrams of example systems 1100, 1200 for implementing and facilitating, respectively, wireless traffic communication for UEs in a CELL_FACH state, according to aspects of the subject disclosure. For example, systems 1100 and 1200 can reside at least partially within a wireless communication network and/or within a transmitter such as a node, base station, access point, user terminal, personal computer coupled with a mobile interface card, or the like. It is to be appreciated that systems 1100 and 1200 are represented as including functional blocks, which can be functional blocks that represent functions implemented by a processor, software, or combination thereof (e.g. firmware).

System 1100 can comprise a first module 1102 for employing a communication interface. The module 1202 can comprise, for instance, a wireless antenna, receiver and transmitter for sending and receiving wireless signals. Additionally, system 1100 can comprise a second module 1204 for generating a message to trigger an uplink response from a UE in a CELL_FACH state. The trigger message can, in some instances, be an SCCH message (e.g., an HS-SCCH message). Additionally, the trigger message can specify data to be included in a response, resources to be utilized for the response, or timing for submitting the response. Further to the above, system 1100 can comprise a third module 1106 for transmitting the trigger message to cause the UE to send the uplink response. In some aspects, the trigger message can comprise an explicit order to send such response. In other aspects, the trigger message can comprise traffic data, for instance where the UE is configured to respond upon receiving traffic data in a predetermined manner known to system 1100.

System 1200 can comprise a first module 1202 for employing a communication interface. The module 1202 can be substantially similar to the module 1102 of system 1100, discussed above. Additionally, system 1200 can comprise a second module 1204 for processing a received uplink trigger message. The uplink trigger message can be received by the first module 1202, in one or more wireless signals. According to particular aspects of the subject disclosure, the uplink trigger message can be received from an SCCH signal. The second module 1204 can decode and analyze such signals, extracting the uplink trigger message there from. Furthermore, the second module 1204 can identify suitable instructions regarding the uplink trigger message, such as channel or packet quality information to be included in an uplink response, channel resources for submitting the response, or timing information for submitting the response. Further to the above, system 1200 can comprise a third module 1206 for submitting an uplink response message based on the uplink trigger message. The third module 1206 can employ resources or timing specified in the uplink trigger message, or acquire such resources or generate such timing independent of the uplink trigger message, as suitable.

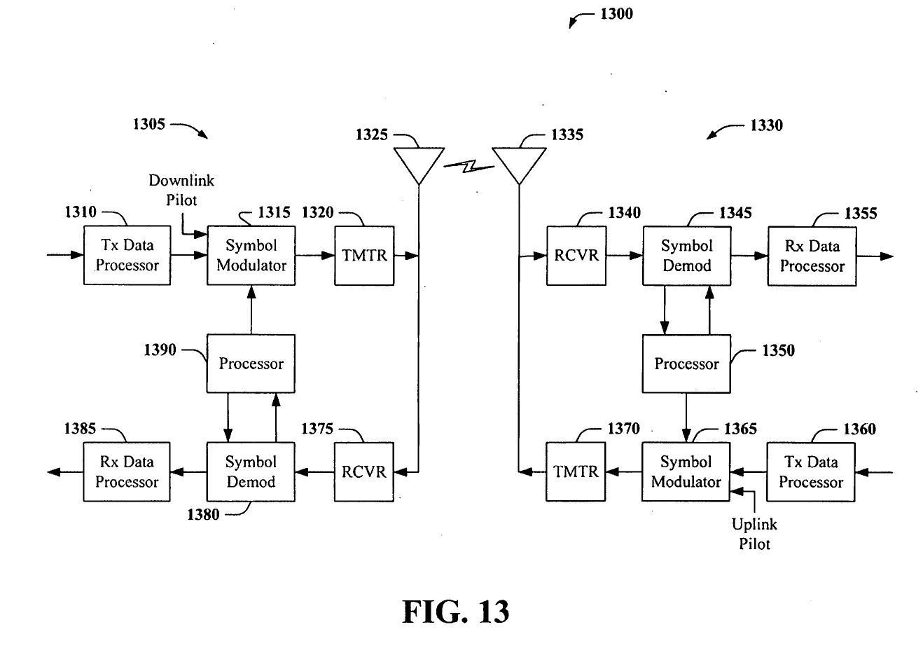

FIG. 13 depicts a block diagram of an example system 1300 that can facilitate wireless communication according to some aspects disclosed herein. On a downlink, at access point 1305, a transmit (TX) data processor 1310 receives, formats, codes, interleaves, and modulates (or symbol maps) traffic data and provides modulation symbols (“data symbols”). A symbol modulator 1315 receives and processes the data symbols and pilot symbols and provides a stream of symbols. A symbol modulator 1320 multiplexes data and pilot symbols and provides them to a transmitter unit (TMTR) 1320. Each transmit symbol can be a data symbol, a pilot symbol, or a signal value of zero. The pilot symbols can be sent continuously in each symbol period. The pilot symbols can be frequency division multiplexed (FDM), orthogonal frequency division multiplexed (OFDM), time division multiplexed (TDM), code division multiplexed (CDM), or a suitable combination thereof or of like modulation and/or transmission techniques.

TMTR 1320 receives and converts the stream of symbols into one or more analog signals and further conditions (e.g. amplifies, filters, and frequency upconverts) the analog signals to generate a downlink signal suitable for transmission over the wireless channel. The downlink signal is then transmitted through an antenna 1325 to the terminals. At terminal 1330, an antenna 1335 receives the downlink signal and provides a received signal to a receiver unit (RCVR) 1340. Receiver unit 1340 conditions (e.g., filters, amplifies, and frequency downconverts) the received signal and digitizes the conditioned signal to obtain samples. A symbol demodulator 1345 demodulates and provides received pilot symbols to a processor 1350 for channel estimation. Symbol demodulator 1345 further receives a frequency response estimate for the downlink from processor 1350, performs data demodulation on the received data symbols to obtain data symbol estimates (which are estimates of the transmitted data symbols), and provides the data symbol estimates to an RX data processor 1355, which demodulates (i.e., symbol demaps), deinterleaves, and decodes the data symbol estimates to recover the transmitted traffic data. The processing by symbol demodulator 1345 and RX data processor 1355 is complementary to the processing by symbol modulator 1315 and TX data processor 1310, respectively, at access point 1305.

On the uplink, a TX data processor 1360 processes traffic data and provides data symbols. A symbol modulator 1365 receives and multiplexes the data symbols with pilot symbols, performs modulation, and provides a stream of symbols. A transmitter unit 1370 then receives and processes the stream of symbols to generate an uplink signal, which is transmitted by the antenna 1335 to the access point 1305. Specifically, the uplink signal can be in accordance with SC-FDMA requirements and can include frequency hopping mechanisms as described herein.

At access point 1305, the uplink signal from terminal 1330 is received by the antenna 1325 and processed by a receiver unit 1375 to obtain samples. A symbol demodulator 1380 then processes the samples and provides received pilot symbols and data symbol estimates for the uplink. An RX data processor 1385 processes the data symbol estimates to recover the traffic data transmitted by terminal 1330. A processor 1390 performs channel estimation for each active terminal transmitting on the uplink. Multiple terminals can transmit pilot concurrently on the uplink on their respective assigned sets of pilot subbands, where the pilot subband sets can be interlaced.

Processors 1390 and 1350 direct (e.g., control, coordinate, manage, etc.) operation at access point 1305 and terminal 1330, respectively. Respective processors 1390 and 1350 can be associated with memory units (not shown) that store program codes and data. Processors 1390 and 1350 can also perform computations to derive frequency and impulse response estimates for the uplink and downlink, respectively.

For a multiple-access system (e.g., SC-FDMA, FDMA, OFDMA, CDMA, TDMA, etc.), multiple terminals can transmit concurrently on the uplink. For such a system, the pilot subbands can be shared among different terminals. The channel estimation techniques can be used in cases where the pilot subbands for each terminal span the entire operating band (possibly except for the band edges). Such a pilot subband structure would be desirable to obtain frequency diversity for each terminal. The techniques described herein can be implemented by various means. For example, these techniques can be implemented in hardware, software, or a combination thereof. For a hardware implementation, which can be digital, analog, or both digital and analog, the processing units used for channel estimation can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes can be stored in memory unit and executed by the processors 1390 and 1350.

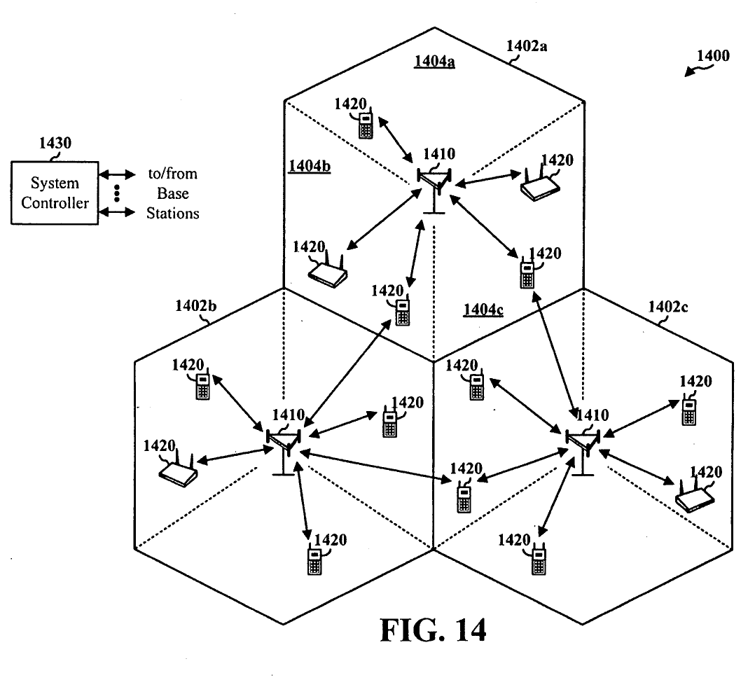

FIG. 14 illustrates a wireless communication system 1400 with multiple base stations (BSs) 1410 (e.g., wireless access points, wireless communication apparatus) and multiple terminals 1420 (e.g., ATs), such as can be utilized in conjunction with one or more aspects. A BS (1410) is generally a fixed station that communicates with the terminals and can also be called an access point, a Node B, or some other terminology. Each BS 1410 provides communication coverage for a particular geographic area or coverage area, illustrated as three geographic areas in FIG. 14, labeled 1402a, 1402b, and 1402c. The term “cell” can refer to a BS or its coverage area depending on the context in which the term is used. To improve system capacity, a BS geographic area/coverage area can be partitioned into multiple smaller areas (e.g., three smaller areas, according to cell 1402a in FIG. 14), 1404a, 1404b, and 1404c. Each smaller area (1404a, 1404b, 1404c) can be served by a respective base transceiver subsystem (BTS). The term “sector” can refer to a BTS or its coverage area depending on the context in which the term is used. For a sectorized cell, the BTSs for all sectors of that cell are typically co-located within the base station for the cell. The transmission techniques described herein can be used for a system with sectorized cells as well as a system with un-sectorized cells. For simplicity, in the subject description, unless specified otherwise, the term “base station” is used generically for a fixed station that serves a sector as well as a fixed station that serves a cell.

Terminals 1420 are typically dispersed throughout the system, and each terminal 1420 can be fixed or mobile. Terminals 1420 can also be called a mobile station, user equipment, a user device, wireless communication apparatus, an access terminal, a user terminal or some other terminology. A terminal 1420 can be a wireless device, a cellular phone, a personal digital assistant (PDA), a wireless modem card, and so on. Each terminal 1420 can communicate with zero, one, or multiple BSs 1410 on the downlink (e.g., FL) and uplink (e.g., RL) at any given moment. The downlink refers to the communication link from the base stations to the terminals, and the uplink refers to the communication link from the terminals to the base stations.

For a centralized architecture, a system controller 1430 couples to base stations 1410 and provides coordination and control for BSs 1410. For a distributed architecture, BSs 1410 can communicate with one another as needed (e.g., by way of a wired or wireless backhaul network communicatively coupling the BSs 1410). Data transmission on the forward link often occurs from one access point to one access terminal at or near the maximum data rate that can be supported by the forward link or the communication system. Additional channels of the forward link (e.g. control channel) can be transmitted from multiple access points to one access terminal. Reverse link data communication can occur from one access terminal to one or more access points.

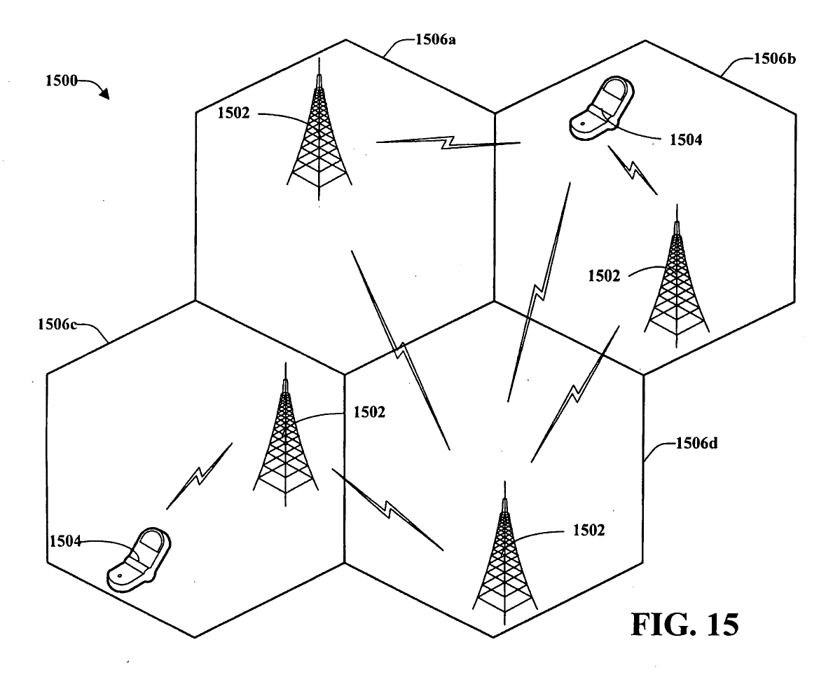

FIG. 15 is an illustration of a planned or semi-planned wireless communication environment 1500, in accordance with various aspects. System 1500 can comprise one or more BSs 1502 in one or more cells and/or sectors that receive, transmit, repeat, etc., wireless communication signals to each other and/or to one or more mobile devices 1504. As illustrated, each BS 1502 can provide communication coverage for a particular geographic area, illustrated as four geographic areas, labeled 1506a, 1506b, 1506c and 1506d. Each BS 1502 can comprise a transmitter chain and a receiver chain, each of which can in turn comprise a plurality of components associated with signal transmission and reception (e.g., processors, modulators, multiplexers, demodulators, demultiplexers, antennas, and so forth, see FIG. 5), as will be appreciated by one skilled in the art. Mobile devices 1504 can be, for example, cellular phones, smart phones, laptops, handheld communication devices, handheld computing devices, satellite radios, global positioning systems, PDAs, or any other suitable device for communicating over wireless network 1500. System 1500 can be employed in conjunction with various aspects described herein in order to facilitate triggering uplink data from CELL_FACH UEs, or identifying and responding to such a trigger, as set forth herein.

Appendix A depicts an example analysis of potential inefficiencies that can result from DL transmission to UEs in a CELL_FACH state, absent uplink feedback. Appendix A further demonstrates the benefits gained if uplink feedback can be triggered and employed for the DL transmission. It is to be understood that Appendix A is hereby incorporated as part of the original disclosure for the subject Application for Patent.

As used in the subject disclosure, the terms “component,” “system,” “module” and the like are intended to refer to a computer-related entity, either hardware, software, software in execution, firmware, middle ware, microcode, and/or any combination thereof. For example, a module can be, but is not limited to being, a process running on a processor, a processor, an object, an executable, a thread of execution, a program, a device, and/or a computer. One or more modules can reside within a process, or thread of execution; and a module can be localized on one electronic device, or distributed between two or more electronic devices. Further, these modules can execute from various computer-readable media having various data structures stored thereon. The modules can communicate by way of local or remote processes such as in accordance with a signal having one or more data packets (e.g. data from one component interacting with another component in a local system, distributed system, or across a network such as the Internet with other systems by way of the signal). Additionally, components or modules of systems described herein can be rearranged, or complemented by additional components/modules/systems in order to facilitate achieving the various aspects, goals, advantages, etc., described with regard thereto, and are not limited to the precise configurations set forth in a given figure, as will be appreciated by one skilled in the art.

Furthermore, various aspects are described herein in connection with a UT. A UT can also be called a system, a subscriber unit, a subscriber station, mobile station, mobile, mobile communication device, mobile device, remote station, remote terminal, access terminal (AT), user agent (UA), a user device, or user equipment (UE). A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

In one or more exemplary embodiments, the functions described can be implemented in hardware, software, firmware, middleware, microcode, or any suitable combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media may be any physical media that can be accessed by a computer. By way of example, and not limitation, such computer storage media can comprise RAM, ROM, EEPROM, CD-ROM or other optical disk storage, magnetic disk storage or other magnetic storage devices, smart cards, and flash memory devices (e.g., card, stick, key drive . . . ), or any other medium that can be used to carry or store desired program code in the form of instructions or data structures and that can be accessed by a computer. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For a hardware implementation, the processing units' various illustrative logics, logical blocks, modules, and circuits described in connection with the aspects disclosed herein can be implemented or performed within one or more ASICs, DSPs, DSPDs, PLDs, FPGAs, discrete gate or transistor logic, discrete hardware components, general purpose processors, controllers, micro-controllers, microprocessors, other electronic units designed to perform the functions described herein, or a combination thereof A general-purpose processor can be a microprocessor, but, in the alternative, the processor can be any conventional processor, controller, microcontroller, or state machine. A processor can also be implemented as a combination of computing devices, e.g. a combination of a DSP and a microprocessor, a plurality of microprocessors, one or more microprocessors in conjunction with a DSP core, or any other suitable configuration. Additionally, at least one processor can comprise one or more modules operable to perform one or more of the steps and/or actions described herein.

Moreover, various aspects or features described herein can be implemented as a method, apparatus, or article of manufacture using standard programming and/or engineering techniques. Further, the steps and/or actions of a method or algorithm described in connection with the aspects disclosed herein can be embodied directly in hardware, in a software module executed by a processor, or in a combination of the two. Additionally, in some aspects, the steps or actions of a method or algorithm can reside as at least one or any combination or set of codes or instructions on a machine-readable medium, or computer-readable medium, which can be incorporated into a computer program product. The term “article of manufacture” as used herein is intended to encompass a computer program accessible from any suitable computer-readable device or media.

Additionally, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, as used herein, the terms to “infer” or “inference” refer generally to the process of reasoning about or inferring states of the system, environment, or user from a set of observations as captured via events, or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events, or data. Such inference results in the construction of new events or actions from a set of observed events and/or stored event data, whether or not the events are correlated in close temporal proximity, and whether the events and data come from one or several event and data sources.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

### APPENDIX A

Appendix A provides a system level simulation study to illustrate the performance impact on downlink (DL) transmissions when a high-speed dedicated physical control channel (HS-DPCCH) is not available to provide uplink feedback for scheduling the DL transmissions. Sector throughput is shown when 10 users per cell are delivering Full-Buffer type traffic. We compare the situation when hybrid automated request (HARQ) acknowledgment/negative acknowledgment (ACK/NAK) feedback is not sent, and DL HS transmissions are repeated a fixed number of times for diversity, to the case when HARQ ACK/NAK feedback is made available via HS-DPCCH. In addition, impact of channel quality information (CQI) sent at varying frequencies of occurrence is provided, including a frequency of occurrence that is comparable to no CQI transmission. Table 1 shows the simulation set up and the cases simulated.

TABLE 1
Simulation Set up

| Parameter | Explanation/Assumption |
|---|---|
| Cellular Layout | Hexagonal grid, 3-cell sites, |
| | 57 cells with wrap around |
| | model, Only central 3 cell |
| | users/traffic modelled |
| Site to Site distance | 500 m |
| Antenna pattern | 0 degree horizontal azimuth |
| | is East 70 degree (−3 dB), |
| | 20 dB front-to-back ratio |
| Propagation model | L = 128.1 + 37.6 Log10(R) |
| Fading Channel model | ITU Typical Urban, 3 km/hr |
| Downlink CPICH power | −10 dB |
| Std. deviation of slow fading | 8.0 dB |
| Correlation between sectors | 1.0 |
| Correlation between sites | 0.5 |
| Correlation distance of slow | 50 m |
| fading | |
| Node B antenna gain plus Cable | 14 dBi |
| Loss | |
| Penetration Loss | 20 dB |
| Node B power | 43 dBm |
| Node B power for HSDSCH | 80% |
| (HSPDSCH + HSSCCH) | |
| UE RX diversity | Single Receive Antenna |
| UE antenna gain | 0 dBi |
| UE receiver | RAKE |
| Carrier frequency | 2000 MHz |
| CQI Feedback Cycle | Varied in the set {1, 8, 100, |
| | 500} TTI. The last CQI |
| | available is used as predicted CQI |
| Repeated transmissions in | Varied in the set {2, 3} |
| absence of HARQ ACK/NAK | |
| Users/Cell | 10 |
| Traffic | Full Buffer, 40 byte PDUs |
| | sent by RLC-AM mode, |
| Scheduler | Proportional Fair |

Table 2 shows application layer sector throughput for distinct cases. In the absence of HARQ ACK/NACK the DL transmissions are repeated 2 or 3 times. The resulting packet errors, if any, are handled by radio link control retransmissions. A large CQI feedback cycle (CQI delay) is used to approximate an absence of CQI. The results indicate that absence of HARQ ACK/NAK and absence of CQI information lead to a severe performance penalty for the DL transmissions as compared to a case where ACK/NAK feedback and fresh CQI information is available through HS-DPCCH. These results suggest exceptional utility for employing an HS-DPCCH uplink in the CELL_FACH state.

TABLE 2
Application layer sector throughput of 10 Full buffer users (Mbps) for different
assumptions on availability of HARQ ACK/NAK and CQI feedback cycles

| Sector Throughput in | CQI Feedback | CQI Feedback | CQI Feedback | CQI Feedback |
|---|---|---|---|---|
| Mbps | Cycle 1 TTI | Cycle 8 TTI | Cycle 100 TTI | Cycle 500 TTI |
| With HARQ | 2.26 | 2.04 | 1.45 | 1.33 |
| ACK/NAK | | | | |
| No HARQ ACK/NAK, | 1.63 | 1.54 | 1.20 | 1.19 |
| 2 repetitions | | | | |
| No HARQ ACK/NAK, | 1.44 | 1.37 | 1.02 | 1.03 |
| 3 repetitions | | | | |

What is claimed is:

1. A method of wireless communication within a wireless network, comprising:
employing a communication interface to exchange wireless signals with one or more wireless user equipment (UE);
employing a data processor to generate a message for a UE in a CELL_FACH state; and
employing the communication interface to trigger an uplink response from the UE in the CELL_FACH state by transmitting the message to the UE.

2. The method of claim 1, wherein triggering the uplink response further comprises ordering the UE to transmit wireless channel data on an uplink channel.

3. The method of claim 2, wherein the wireless channel data comprises acknowledgement (ACK)/negative acknowledgement (NACK) data, or channel quality information (CQI) data.

4. The method of claim 1, further comprising employing a shared control channel to transmit the message to the UE.

5. The method of claim 1, further comprising ordering the UE to transmit high speed dedicated physical control channel (HS-DPCCH) uplink data along with dedicated physical control channel (DPCCH) uplink data.

6. The method of claim 1, further comprising specifying an identity (ID) of a resource to be used on the uplink response.

7. The method of claim 6, wherein specifying the ID of the resource comprises indicating a 5-bit enhanced dedicated channel (E-DCH) for the uplink response.

8. The method of claim 6, further comprising employing an unused bit combination of a high speed shared control channel (HS-SCCH) to specify the ID of the resource.

9. The method of claim 1, further comprising:
identifying application traffic routed for the UE;
sending a subset of the application traffic with the message over a downlink (DL) shared channel; and
delaying DL transmission of further subsets of the application traffic until a radio link control (RLC) ACK or STATUS packet data unit (STATUS PDU) response is obtained from the UE.

10. The method of claim 1, further comprising employing a HS-SCCH to transmit the message and trigger the uplink response.

11. The method of claim 1, wherein triggering the uplink response from the UE results from obtaining traffic data to be downloaded to the UE.

12. An apparatus for wireless communication in a wireless network, comprising:
a communication interface that facilitates transmitting or receiving data over-the-air (OTA) via wireless communication signals;
a data processor configured to analyze decoded signals pertaining to wireless nodes within the wireless network;
a traffic module that identifies inbound traffic for a UE in a CELL_FACH state; and
a feedback module that sends a message to the UE to trigger an uplink response from the UE, wherein the uplink response is employed by the data processor to transmit the inbound traffic over the communication interface.

13. The apparatus of claim 12, wherein the feedback module includes within the message an explicit order to transmit the uplink response after receiving the message.

14. The apparatus of claim 12, wherein the data processor extracts ACK/NACK or CQI data from the uplink response to improve efficiency or effectiveness of the transmission.

15. The apparatus of claim 12, wherein the feedback module employs a shared channel to transmit the message to the UE.

16. The apparatus of claim 15, wherein the shared control comprises an HS-SSCH.

17. The apparatus of claim 12, further comprising a scheduling module that orders the UE to transmit HS-DPCCH uplink data in conjunction with DPCCH uplink data, wherein the order is included in the message.

18. The apparatus of claim 12, further comprising a resource module that specifies an ID of a resource for the uplink response.

19. The apparatus of claim 18, wherein the resource ID comprises a 5-bit E-DCH ID.

20. The apparatus of claim 18, wherein the resource module employs an unused bit combination of a DL shared channel to transmit the resource ID to the UE.

21. The apparatus of claim 12, further comprising:
a partition module that segments the inbound traffic at least into an initial segment and a subsequent segment, wherein the feedback module includes the initial segment of the inbound traffic in the message sent to trigger the uplink response; and
a traffic interruption module that delays transmission of the subsequent segment of the inbound traffic to the UE until the uplink response is received at the apparatus.

22. The apparatus of claim 12, further comprising an uplink coordination module that specifies a time for sending the uplink response after receipt of the message.

23. An apparatus for wireless communication in a wireless network, comprising:
means for employing a communication interface to exchange wireless signals with one or more wireless UE;
means for employing a data processor to generate a message for a UE in a CELL_FACH state; and
means for employing the communication interface to trigger an uplink response from the UE in the CELL_FACH state by transmitting the message to the UE.

24. At least one processor configured for wireless communication in a wireless network; comprising:
a first module that employs a communication interface to exchange wireless signals with one or more wireless UE;
a second module that generates a message for a UE in a CELL_FACH state; and
a third module that triggers an uplink response from the UE in the CELL_FACH state by transmitting the message to the UE.

25. A computer program product, comprising:
a computer-readable medium, comprising:
a first set of codes for causing a computer to employ a communication interface to exchange wireless signals with one or more wireless UE;
a second set of codes for causing the computer to generate a message for a UE in a CELL_FACH state; and
a third set of codes for causing the computer to employ the communication interface to trigger an uplink response from the UE in the CELL_FACH state by transmitting the message to the UE.

26. A method of facilitating efficient wireless communications, comprising:
employing a wireless communication interface of a UE in a CELL_FACH state to receive system or traffic information from a wireless network access point (AP);
employing at least one processor to analyze received shared control channel signals from the AP in accordance with the CELL_FACH state; and
employing the wireless communication interface to submit channel information on an uplink in response to a message received from the AP via the shared control channel.

27. The method of claim 26, further comprising employing the processor(s) to extract from the message an ID of a channel resource for submitting the channel information.

28. The method of claim 27, wherein the ID of the channel resource comprises an E-DCH ID transmitted over unused bits of the shared control channel.

29. The method of claim 26, further comprising employing the processor(s) to extract an explicit order to submit the channel information from received shared control channel signals.

30. The method of claim 29, wherein the submission of channel information is in response to the explicit order.

31. The method of claim 26, further comprising submitting CQI information in response to the message.

32. The method of claim 26, further comprising analyzing the system information to identify expected received data, and sending an ACK/NACK regarding the expected data.

33. The method of claim 26, further comprising transmitting HS-DPCCH data in conjunction with DPCCH data based on the message.

34. The method of claim 26, further comprising identifying an instance of traffic data within the message, wherein the channel information comprises an RLC ACK or STATUS PDU.

35. The method of claim 34, further comprising determining timing for submitting the channel information from the message, or by referencing a pre-determined network protocol.

36. The method of claim 26, further comprising monitoring a broadcast channel (BCH) and identifying a common E-DCH to receive the system or traffic information in the CELL_FACH state.

37. An apparatus for facilitating efficient wireless communication in a wireless network, comprising:
a wireless communication interface for sending or receiving data via wireless signals;
a data processor for analyzing wireless signals transmitted by an AP of the wireless network;
a network-response module that identifies a shared control channel message transmitted by the AP and transmits an uplink message in response to the shared control channel message.

38. The apparatus of claim 37, further comprising an access module that initiates a random channel access procedure in response to receiving the shared control channel message, to facilitate transmission of the uplink message.

39. The apparatus of claim 37, wherein the data processor extracts an ID of a channel resource from the message for the uplink message transmission.

40. The apparatus of claim 39, wherein the ID of the channel resource comprises an ID of an E-DCH.

41. The apparatus of claim 37, wherein the shared control channel message comprises an explicit order to transmit the uplink message.

42. The apparatus of claim 41, wherein the network-response module transmits the uplink message with response timing or on a resource specified by the explicit order.

43. The apparatus of claim 37, further comprising a measurement module that determines interference, path-loss, multi-path scattering or channel noise data of a downlink channel employed by the AP and submits the data in the uplink message.

44. The apparatus of claim 37, further comprising a packet tracking module that submits ACK/NACK information in response to receipt of the shared control channel message.

45. The apparatus of claim 37, wherein the network-response module transmits the uplink message on a HS-DPCCH channel in response to the shared control channel message.

46. The apparatus of claim 37, wherein:
the data processor identifies traffic data within the shared control channel message; and
the network-response module includes an RLC ACK or STATUS PDU with the uplink message.

47. The apparatus of claim 46, further comprising a timing module that employs a protocol to determine a delay for transmitting the response message, or extracts the delay from the shared control channel message.

48. An apparatus configured to facilitate efficient wireless communications, comprising:
means for employing a wireless communication interface configured in a CELL_FACH state to receive system or traffic information from a wireless network AP;
means for employing at least one processor to analyze received shared control channel signals from the AP in accordance with the CELL_FACH state; and
means for employing the wireless communication interface to submit channel information on an uplink in response to a message received from the AP via the shared control channel.

49. At least one processor configured to facilitate efficient wireless communications, comprising:
a first module that employs a wireless communication interface of a UE in a CELL_FACH state to receive system or traffic information from a wireless network AP;
a second module that analyzes received shared control channel signals from the AP in accordance with the CELL_FACH state; and
a third module for employing the wireless communication interface to submit channel information on an uplink in response to a message received from the AP via the shared control channel.

50. A computer program product, comprising:
a computer-readable medium, comprising:
a first set of codes for causing a computer to employ a wireless communication interface configured in a CELL_FACH state to receive system or traffic information from a wireless network AP;
a second set of codes for causing the computer to analyze received shared control channel signals from the AP in accordance with the CELL_FACH state; and
a third set of codes for causing the computer to employ the wireless communication interface to submit channel information on an uplink in response to a message received from the AP via the shared control channel.
